(19) United States
(12) Patent Application Publication
(10) Pub. No.: US 2016/0029265 A1
(43) Pub. Date: Jan. 28, 2016

(54) METHOD AND APPARATUS FOR MOBILITY CONTROL IN A HETEROGENOUS NETWORK

(71) Applicant: NOKIA TECHNOLOGIES OY, Espoo (FI)

(72) Inventor: Haitao LI, Beijing (CN)

(21) Appl. No.: 14/771,782

(22) PCT Filed: Mar. 21, 2013
(86) PCT No.: PCT/CN2013/072983

§ 371 Date: Aug. 31, 2015

(51) Int. Cl. H04W 36/00; H04W 36/30; H04W 36/04; H04W 24/10

(52) U.S. Cl. CPC H04W 36/0083; H04W 36/0061; H04W 24/10; H04W 36/30; H04W 36/04; H04W 88/08

(57) ABSTRACT

A method, corresponding apparatuses, and a computer program product for enhancing small cell mobility are provided. The method comprises measuring a first channel quality level in a primary serving cell over a primary component carrier. The method also comprises measuring a second channel quality level in a secondary serving cell over a secondary component carrier. The method further comprises performing neighbor cell measurement on a list of frequency carriers if the first channel quality level is higher than a first threshold value and the second channel quality level is lower than a second threshold value. With the claimed inventions, small cell layer's neighbor cell measurement would be also triggered by SCell's quality degradation, which may result in less UE power consumption. Further, measurement gap is used more economically and causes less impact on UE's data rate and throughput.

### FIELD OF THE INVENTION

Example embodiments of the present invention generally relate to wireless communication techniques including the 3GPP (the 3rd Generation Partnership Project) LTE (Long Term Evolution) technique. More particularly, example embodiments of the present invention relate to a method, corresponding apparatus, and a computer program product for mobility control in a heterogeneous network.

### BACKGROUND OF THE INVENTION

Various abbreviations that appear in the specification and/or in the drawing figures are defined as below:

CA Carrier Aggregation

CN Core Network

eNB evolved Node B

PCell Primary Cell

RAN Radio Access Network

RRC Radio Resource Control

RSRP Reference Signal Received Power

RSRQ Reference Signal Received Quality

S cell Secondary Cell

UE User Equipment

The following description of background art may include insights, discoveries, understandings or disclosures, or associations together with disclosures not known to the relevant art prior to the present invention but provided by the present invention. Some such contributions of the present invention may be specifically pointed out below, while other such contributions of the present invention will be apparent from their context.

Enhancements to a small cell, such as picocells or femtocells (also known as home-eNB cells) that operate in licensed spectrums, are a major Rel-12 Study Item launched in the beginning of 2013 in 3GPP RAN2. This Study Item aims at enhancing small cell architecture with less CN impact, identifying benefits of UE with dual connectivity to small cell layer and macro layer, and also enhancing mobility performance especially for inter-small cell mobility procedure.

Dual connectivity to both macro layer and small cell layer can bring many benefits to the UE, such as increased data rate, robust mobility control, and so on. Network can also benefit from it in terms of flexible offloading and load balancing. To model dual connectivity, inter-site CA, or inter-eNB CA, is one of feasible options. Typically, PCell is managed on a macro layer and SCell is done on a small cell layer. As the macro cell has relatively large coverage as compared to the small cell, when UE moves, it usually encounters with more frequent inter-small cell mobility than inter-macro mobility. Therefore, enhancement for inter-small cell mobility should be well studied.

Following existing 3GPP principles, connected mode UE mobility is done by a network-controlled handover procedure, most of which is triggered by UE's measurement report. If an inter-site CA model is taken for modeling dual connectivity and if existing co-site CA specifications (i.e., Rel-10 specs, e.g. 36.331) are referred to, then UE's measurement behavior is mainly designed based on PCell's quality. That is, UE's neighbor cell measurement campaign is enabled/disabled depending on whether PCell's quality is lower than a configured s-measure value or not. More specifically, when PCell's RSRP value characterizing the channel quality of the PCell is lower than the s-measure value, the UE starts all (including intra-frequency, inter-frequency and inter-RAT) neighbor cell measurements; otherwise, the UE stops neighbor cell measurements for power saving.

For co-site CA, the existing measurement mechanism may have a good performance because the PCell quality, as in most cases, can somehow represent SCell's quality especially when both PCell and Scell may have a common coverage area. However, for inter-site CA with physically separately located small cells, such measurement mechanism may not be sufficient and power-efficient for small cell mobility management. That is because when a UE is leaving a small cell, its PCell quality may still be in a good condition so that the UE won't start measuring neighbor cells. In this case, PCell's RSRP value might not be effective in determining whether or not to start measuring neighbor cells and therefore might be inappropriate for identifying the candidate small cells. This will lead to SCell drop and thus user-plane capacity will be decreased.

One possible approach to this is by always disabling the s-measure mechanism. In that case, UE will always perform neighbor cell measurement regardless of mobility needs. This certainly can enable small cell detection and SCell replacement; however, it will cause too much UE power consumption as most of the time UE might be able to live with its current SCell(s).

### SUMMARY OF THE INVENTION

The following presents a simplified summary of the present invention in order to provide a basic understanding of some aspects of the present invention. It should be noted that this summary is not an extensive overview of the present invention and that it is not intended to identify key/critical elements of the present invention or to delineate the scope of the present invention. Its sole purpose is to present some concepts of the present invention in a simplified form as a prelude to the more detailed description that is presented later.

One embodiment of the present invention provides a method. The method comprises measuring a first channel quality level in a primary serving cell over a primary component carrier. The method also comprises measuring a second channel quality level in a secondary serving cell over a secondary component carrier. The method further comprises performing neighbor cell measurement on a list of frequency carriers if the first channel quality level is higher than a first threshold value and the second channel quality level is lower than a second threshold value.

In one example embodiment, the first channel quality level and the second channel quality level are at least one of a reference signal received power level and a reference signal received quality level

In a further example embodiment, the list of frequency carriers is a list of potential secondary component carriers.

In another example embodiment, the method further comprises receiving, from a serving base station, a radio resource control message, wherein the radio resource control message at least includes information regarding the list of the potential secondary component carriers, one or more second threshold values, one or more potential secondary serving cell identifiers respectively corresponding to the one or more second threshold values.

In an example embodiment, the method further comprises disabling neighbor cell measurement on all carriers that are configured as measurement objects if the first channel quality level is higher than the first threshold value and the second channel quality level is higher than the second threshold value.

In another example embodiment, the method further comprises enabling neighbor cell measurement on all carriers that are configured as measurement objects if the first channel quality level is lower than the first threshold value

In an additional example embodiment, the primary serving cell and the secondary serving cell are served by a same base station.

In yet another example embodiment, the primary serving cell and the secondary serving cell are served by different base stations.

One embodiment of the present invention provides an apparatus. The apparatus comprises means for measuring a first channel quality level in a primary serving cell over a primary component carrier. The apparatus also comprises means for measuring a second channel quality level in a secondary serving cell over a secondary component carrier. The apparatus further comprises means for performing neighbor cell measurement on a list of potential secondary component carriers if the first channel quality level is higher than a first threshold value and the second channel quality level is lower than a second threshold value.

A further embodiment of the present invention provides an apparatus. The apparatus comprises at least one processor and at least one memory including computer program instructions. The at least one memory and computer program instructions are configured to, with the at least one processor, cause the apparatus at least to measure a first channel quality level in a primary serving cell over a primary component carrier. The at least one memory and computer program instructions are also configured to, with the at least one processor, cause the apparatus at least to measure a second channel quality level in a secondary serving cell over a secondary component carrier. The at least one memory and computer program instructions are further configured to, with the at least one processor, cause the apparatus at least to perform neighbor cell measurement on a list of potential secondary component carriers if the first channel quality level is higher than a first threshold value and the second channel quality level is lower than a second threshold value.

One embodiment of the present invention provides a computer program product, comprising at least one computer readable storage medium having a computer readable program code portion stored thereon. The computer readable program code portion comprises program code instructions for measuring a first channel quality level in a primary serving cell over a primary component carrier. The computer readable program code portion also comprises program code instructions for measuring a second channel quality level in a secondary serving cell over a secondary component carrier. The computer readable program code portion also comprises program code instructions for performing neighbor cell measurement on a list of potential secondary component carriers if the first channel quality level is higher than a first threshold value and the second channel quality level is lower than a second threshold value.

According to the example embodiments of the present invention as presented above, small cell layer's neighbor cell measurement would also be triggered by SCell's quality degradation, which may result in less UE power consumption. Further, measurement gap is used more economically and causes less impact on UE's data rate and throughput.

### BRIEF DESCRIPTION OF THE DRAWINGS

The example embodiments of the present invention that are presented in the sense of examples and their advantages are explained in greater detail below with reference to the accompanying drawings, in which:

FIG. 1 illustrates an exemplary heterogeneous network in which the example embodiments of the present invention can be practiced;

FIG. 2 is a flow chart schematically illustrating a method for mobility control in a heterogeneous network according to an example embodiment of the present invention;

FIG. 3 is a flow chart schematically illustrating in detail a method for mobility control in a heterogeneous network according to another example embodiment of the present invention; and

FIG. 4 is a simplified schematic block diagram illustrating apparatuses according to example embodiments of the present invention.

### DETAILED DESCRIPTION OF EMBODIMENTS

Current release-10 TS 36.331 has specified an s-measure mechanism, in which the s-measure is a PCell quality threshold controlling whether or not the UE is required to perform measurements of intra-frequency, inter-frequency and inter-RAT neighboring cells. Value “0” indicates to disable s-measure. When PCell's RSRP is lower than the s-measure, UE starts intra-freq/inter-freq/inter-RAT neighbor cell measurements (if a gap is already configured when needed); otherwise, UE stops neighbor cell measurements for power saving. However, as previously mentioned, in the dual connectivity scenario, only the s-measure cannot correctly determine whether or not to perform neighbor cell measurement.

In view of the above, example embodiments of the present invention propose a power-efficient mobility enhancement scheme, especially on measurement enhancement with less UE power consumption, over dual connectivity mode. In particular, the example embodiments of the present invention define a new hybrid measurement mechanism for SCell mobility management, particularly in inter-site CA scenarios. The main idea is to involve a RRC signaling for the network to configure a new parameter (secondary s-measure) and corresponding applicable frequency carriers to the UE. These applicable frequency carriers normally refer to those small cell frequency carriers. When UE receives such new parameters, it evaluates the SCell quality, such as characterized by the SCell's RSRP or RSRQ value, against the configured secondary s-measure value to decide whether to turn on or not the neighbor cell measurement on the indicated small cell layers. This new mechanism goes in a backwards compatible way, which means existing release-10 s-measure mechanism may remain unchanged if these new parameters are not configured.

The example embodiments of the present invention will be described in detail in connection with accompanying drawings.

FIG. 1 illustrates an exemplary heterogeneous network 100 in which the example embodiments of the present invention can be practiced. As illustrated in FIG. 1, in the heterogeneous network (“HetNet” for short) 100, a UE is in connection with a macro eNB and a small cell eNB, i.e., in a dual connectivity mode. The coverage areas of the eNBs are depicted by ellipses of different sizes, wherein the coverage area of the macro eNB is much larger than that of the small cell eNB and overlays the coverage area of the small cell eNB. The macro eNB is connection with the small cell eNB via an X2 interface. It should be noted that only one secondary cell is shown for a simplified purpose and there may exist multiple secondary cells under the coverage area of the macro eNB and thus may provide component carriers F3, F4, F5, . . . , for UE's measurement, mobility decision-making and CA.

In the dual connectivity mode, if the CA is supported, the UE may be served by multiple cells over different component carriers of a serving eNB. For example, as shown in FIG. 1, the UE is served by the macro eNB (i.e., primary serving cell (PCell)) over a primary component carrier F1. The UE is also served by the small cell eNB (i.e., secondary serving cell (SCell)) over secondary component carrier F2.

In the HetNet scenario as depicted in FIG. 1, wireless service operators, if owning plenty of spectrum, usually deploy a set of macro frequencies and a set of small cell frequencies (e.g., F1 and F2 as illustratively depicted). Such kind of deployment can eliminate the need of co-channel interference/cancellation between small cells and macro cells, and can also facilitate high end-user throughput by utilizing dual connectivity simultaneously, e.g. by performing inter-site CA. In the inter-site CA, UE's movement among small cells leads to SCell mobility. Such SCell mobility usually does not have impact on PCell as long as UE is moving within the coverage area of the same macro cell (i.e., PCell), e.g., the bigger ellipse as depicted in FIG. 1. SCell mobility, or more specifically referred to as SCell replacement, is important for maintaining UE's data rate and end user's experience. Fast SCell replacement is always required to avoid data rate degradation or even data interruption.

To this end, according to the example embodiments of the present invention, for UE working under the inter-site CA, the network (e.g., the serving macro eNB) configures a new parameter, referred to as secondary s-measure, to the UE by the RRC dedicated signaling. Along with this secondary s-measure parameter, the network also signals UE a set of frequency carriers which normally refer to those small cell carriers (e.g., F2 as one of them). The existing measurement configuration message is suitable for containing these parameters. Thereby, the UE may perform neighbor cell measurement on the basis of the s-measure and newly-added secondary s-measure.

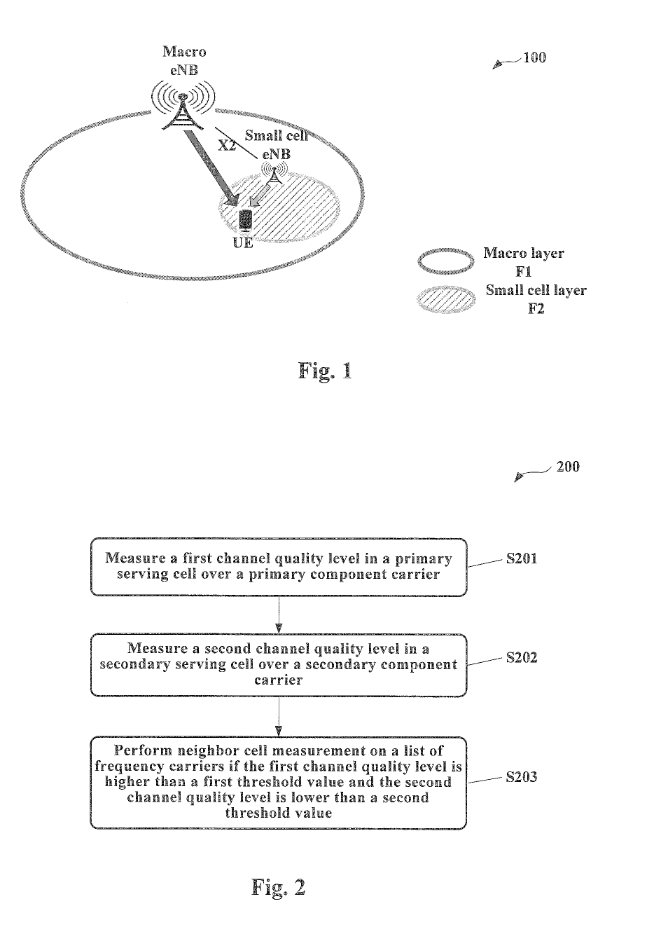

FIG. 2 is a flow chart schematically illustrating a method 200 for mobility control in a heterogeneous network according to an example embodiment of the present invention. As illustrated in FIG. 2, at step S201, the method 200 measures a first channel quality level in a primary serving cell over a primary component carrier. After that, the method 200 proceeds to step S202, at which the method 200 measures a second channel quality level in a secondary serving cell over a secondary component carrier.

Then, at step S203, the method 200 performs neighbor cell measurement on a list of frequency carriers (including, e.g., F2 as depicted in FIG. 1) if the first channel quality level is higher than a first threshold value and the second channel quality level is lower than a second threshold value.

Although not shown, in some example embodiments, the first channel quality level and the second channel quality level are at least one of an RSRP level and an RSRQ level. It should be noted that the various names used for the described parameters (e.g., RSRP, RSRQ, etc.) are not intended to be limiting in any respect, as these parameters may be identified by any suitable names. Further, the various names assigned to different thresholds are not intended to be limiting in any respect, as these various thresholds may be identified by any suitable names. In some example embodiments, the list of frequency carriers is a list of potential secondary component carriers.

In some other example embodiments, the method 200 further comprises receiving, from a serving BS (e.g., the macro eNB as depicted in FIG. 1), an RRC message, wherein the RRC message at least includes information regarding the list of the potential secondary component carriers, one or more second threshold values, one or more potential secondary serving cell identifiers respectively corresponding to the one or more second threshold values.

In some example embodiments, the method 200 further comprises disabling neighbor cell measurement on all carriers that are configured as measurement objects if the first channel quality level is higher than the first threshold value and the second channel quality level is higher than the second threshold value. In the CA scenario, different carrier frequencies to be measured are specified by measurement objects. A measurement object may be set for each configured component carrier to measure neighbor cells on that component carrier. A measurement object may also set for un-configured component carrier to measure neighbor cells on that component carrier.

In some other example embodiments, the method 200 further comprises enabling neighbor cell measurement on all carriers that are configured as measurement objects if the first channel quality level is lower than the first threshold value. Further, in some example embodiments, the primary serving cell and the secondary serving cell are served by a same BS. In some other example embodiments, the primary serving cell and the secondary serving cell are served by different BSs. Thereby, it can be seen that the example embodiments of the present invention may not only be applicable to inter-site CA but also intra-site CA scenarios.

With the method 200 and its multiple variants and extensions as explained in the example embodiments of the present invention, by virtue of newly-introduced second threshold value (i.e., secondary s-measure), small cell layer's neighbor cell measurement would be also triggered by SCell's quality degradation, thereby significantly saving the UE's power consumption. Further, the measurement gap would be utilized more economically and cause less impact on the UE's data rate and throughput. Additionally, the handover latency and service continuity due to UE's mobility can also be improved.

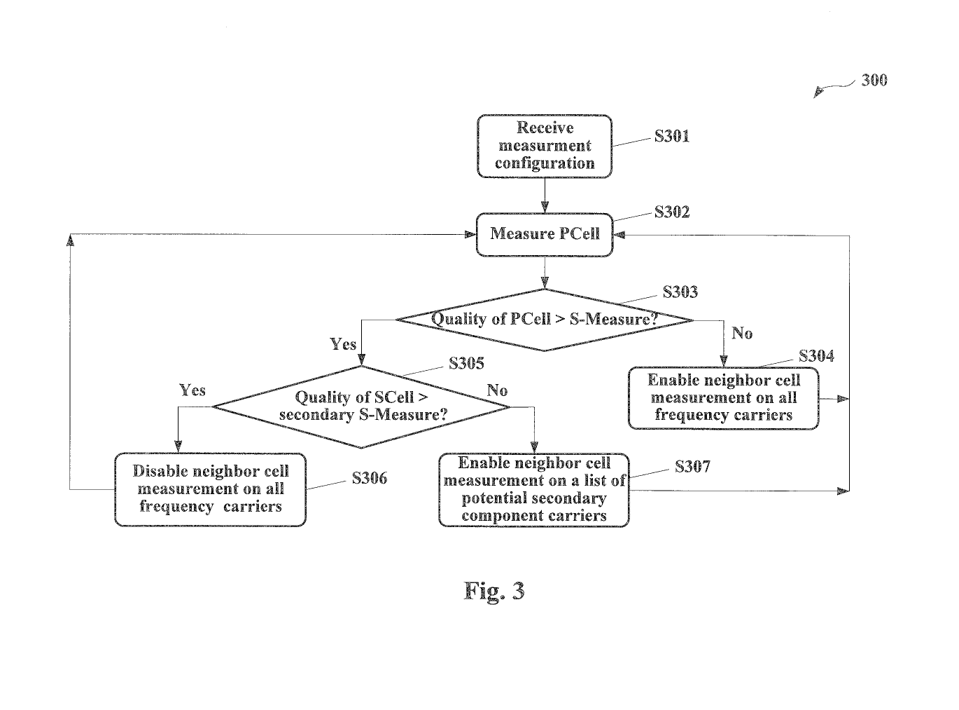

FIG. 3 is a flow chart schematically illustrating in detail a method 300 for mobility control in a heterogeneous network according to another example embodiment of the present invention. As illustrated in FIG. 3, the method 300 commences with the UE receiving network's measurement configuration including new secondary s-measurement and a list of frequency carriers via an RRC message at step S301. In particular, the RRC message at least includes information regarding the list of the potential secondary component carriers, one or more second threshold values, and one or more potential secondary serving cell identifiers respectively corresponding to the one or more second threshold values (i.e., secondary s-measure values).

At step S302, the UE measures the PCell's RSRP at step S302 and at step S303, the UE evaluates PCell's RSRP value, which indicates the channel quality of the PCell, against the legacy s-measure value to decide whether to turn on/off all neighbor cell measurement. If the result of the comparison at step S303 is No, then the flow branches to step S304, at which the UE enables neighbor cell measurement on all frequency carriers configured as measurement objects. In other words, the UE may start neighbor cell measurement on all frequency carriers including a list of potential secondary component carriers.

If the result of the comparison at step S303 is Yes, then the flow branches to step S305, at which the UE evaluates SCell's RSRP or RSRQ value, which indicates the channel quality of the SCell, against the secondary s-measure value to decide whether to turn on/off neighbor cell measurement on the listed frequency carriers. If the result of the comparison is Yes, then at step S306, the UE disables neighbor cell measurement on all frequency carriers. Otherwise, then at step S307, the UE enables neighbor cell measurement on the list of potential secondary component carriers. If the flow goes through steps S304, S306 or S307, it may loop back to step S302 for a next round of UE's mobility decision.

It can be seen from the above description in connection with FIG. 3, by this hybrid s-measure scheme, when the need for SCell replacement arises under the situation that the PCell is of good quality, the UE will only need to perform small cell measurement over a list of frequency carriers, such as a list of potential secondary component carriers. Thus, it can save UE's more battery and have less impact on user data throughput as normally inter-frequency measurement requires measurement gap and causes more power consumption. In some sense, measurement gap is used in a more economical way because measuring more frequency carriers always requires a longer measurement gap periodicity. According to example embodiments of the present invention, by having secondary s-measure control, neighbor small cell measurement can save the long measurement gap.

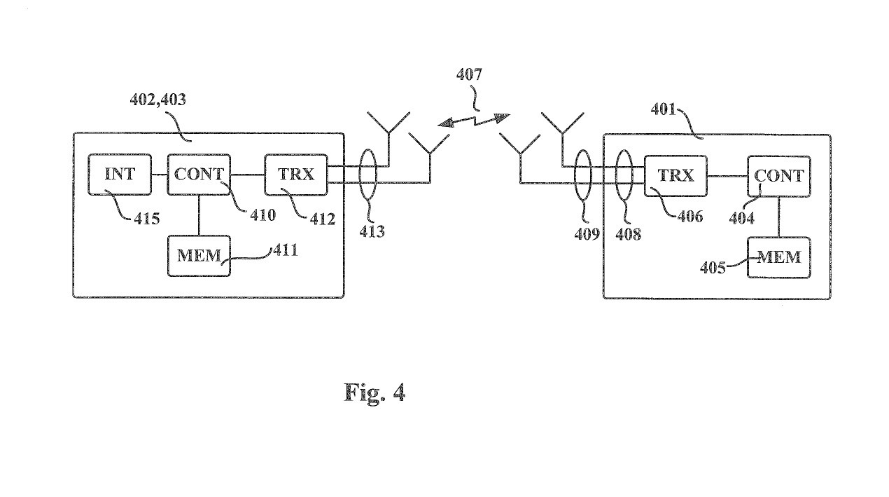

FIG. 4 is a simplified schematic block diagram illustrating apparatuses according to example embodiments of the present invention. As illustrated in FIG. 4, a UE 401 is located in the coverage of a radio network node 402 or 403 and is configured to be in connection with one or both of the radio network nodes 402 and 403, which may be embodied as a macro eNB or a small cell eNB as discussed before according to example embodiments of the present invention. The UE 401 comprises a controller 404 operationally connected to a memory 405 and a transceiver 406. The controller 404 controls the operation of the UE 401. The memory 405 is configured to store software and data. The transceiver 406 is configured to set up and maintain a wireless connection 407 to the radio network node 402 or 403. The transceiver 406 is operationally connected to a set of antenna ports 408 connected to an antenna arrangement 409. The antenna arrangement 409 may comprise a set of antennas. The number of antennas may be one to four, for example. The number of antennas is not limited to any particular number. The UE 401 may also comprise various other components, such as a user interface, camera, and media player. They are not displayed in the figure due to simplicity.

The radio network node 402 or 403 comprises a controller 410 operationally connected to a memory 411, and a transceiver 412. The controller 410 controls the operation of the radio network node 402 or 403. The memory 411 is configured to store software and data. The transceiver 412 is configured to set up and maintain a wireless connection to the UE 401 within the service area of the radio network node 402 or 403. The transceiver 412 is operationally connected to an antenna arrangement 413. The antenna arrangement 413 may comprise a set of antennas. The number of antennas may be two to four, for example. The number of antennas is not limited to any particular number. Although not shown, the radio network node 402 or 403 may be operationally connected (directly or indirectly) to another CN or LAN network element of the communication system, such as an RNC, an MME, an MSC server (MSS), an MSC, an RRM node, a gateway GPRS support node, an OAM node, an HLR, a VLR, a serving GPRS support node, a GW, and/or a server, via an interface 415.

Although the apparatus 401, 402, or 403 has been depicted as one entity, different modules and memory may be implemented in one or more physical or logical entities. The apparatus may also be a user terminal which is a piece of equipment or a device that associates, or is arranged to associate, the user terminal and its user with a subscription and allows a user to interact with a communication system. The user terminal presents information to the user and allows the user to input information. In other words, the user terminal may be any terminal capable of receiving information from and/or transmitting information to the network, connectable to the network wirelessly or via a fixed connection. Examples of the user terminals include a game console, a laptop (a notebook), a personal digital assistant, a mobile station (mobile phone), a smart phone, a communicator, a tablet or a pad.

The apparatus 401, 402, or 403 may generally include a processor, controller, control unit or the like connected to a memory and to various interfaces of the apparatus. Generally the processor is a central processing unit, but the processor may be an additional operation processor. The processor may comprise a computer processor, application-specific integrated circuit (ASIC), field-programmable gate array (FPGA), and/or other hardware components that have been programmed in such a way to carry out one or more functions of the embodiments of the present invention, such as measuring channel quality of PCell and one or more SCells and then determining, based on the s-measure value and the secondary s-measure value as introduced according to example embodiments of the present invention, whether or not enable measuring a list of applicable secondary component carriers.

The memory 405 or 411 may include volatile and/or non-volatile memory and typically stores content, data, or the like. For example, the memory 405 or 411 may store computer program code such as software applications (for enhancing small cell mobility by addition of a secondary s-measure value for a list of secondary component carriers sent via an RRC message) or operating systems, information, data, content, or the like for a processor to perform steps associated with operation of the apparatus 401, 402, or 403 in accordance with example embodiments of the present invention. The memory may be, for example, a random access memory (RAM), a hard drive, or other fixed data memories or storage devices. Further, the memory, or part of it, may be removable memory detachably connected to the apparatus.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g., procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1-25. (canceled)

26. A method, comprising:
measuring a first channel quality level in a primary serving cell over a primary component carrier;
measuring a second channel quality level in a secondary serving cell over a secondary component carrier; and
performing neighbor cell measurement on a list of frequency carriers if the first channel quality level is higher than a first threshold value and the second channel quality level is lower than a second threshold value.

27. The method according to claim 26, wherein the first channel quality level and the second channel quality level are at least one of a reference signal received power level and a reference signal received quality level.

28. The method according to claim 26, wherein the list of frequency carriers is a list of potential secondary component carriers.

29. The method according to claim 28, further comprising:
receiving, from a serving base station, a radio resource control message,
wherein the radio resource control message at least includes information regarding the list of the potential secondary component carriers, one or more second threshold values, one or more potential secondary serving cell identifiers respectively corresponding to the one or more second threshold values.

30. The method according to claim 26, further comprising:
disabling neighbor cell measurement on all carriers that are configured as measurement objects if the first channel quality level is higher than the first threshold value and the second channel quality level is higher than the second threshold value.

31. The method according to claim 26, further comprising:
enabling neighbor cell measurement on all carriers that are configured as measurement objects if the first channel quality level is lower than the first threshold value.

32. The method according to claim 26, wherein the primary serving cell and the secondary serving cell are served by a same base station.

33. The method according to claim 26, wherein the primary serving cell and the secondary serving cell are served by different base stations.

34. An apparatus, comprising:
at least one processor; and
at least one memory including compute program instructions,
wherein the at least one memory and computer program instructions are configured to, with the at least one processor, cause the apparatus at least to:
measure a first channel quality level in a primary serving cell over a primary component carrier;
measure a second channel quality level in a secondary serving cell over a secondary component carrier; and
perform neighbor cell measurement on a list of potential secondary component carriers if the first channel quality level is higher than a first threshold value and the second channel quality level is lower than a second threshold value.

35. The apparatus according to claim 34, wherein the first channel quality level and the second channel quality level are at least one of a reference signal received power level and a reference signal received quality level.

36. The apparatus according to claim 34, wherein the list of frequency carriers is a list of potential secondary component carriers.

37. The apparatus according to claim 36, wherein the at least one memory and computer program instructions are configured to, with the at least one processor, further cause the apparatus at least to:
receive, from a serving base station, a radio resource control message,
wherein the radio resource control message at least includes information regarding the list of the potential secondary component carriers, one or more second threshold values, one or more potential secondary serving cell identifiers respectively corresponding to the one or more second threshold values.

38. The apparatus according to claim 34, wherein the at least one memory and computer program instructions are configured to, with the at least one processor, further cause the apparatus at least to:
disable neighbor cell measurement on all carriers that are configured as measurement objects if the first channel quality level is higher than the first threshold value and the second channel quality level is higher than the second threshold value.

39. The apparatus according to claim 34, wherein the at least one memory and computer program instructions are configured to, with the at least one processor, further cause the apparatus at least to:
enable neighbor cell measurement on all carriers that are configured as measurement objects if the first channel quality level is lower than the first threshold value.

40. The apparatus according to claim 34, wherein the primary serving cell and the secondary serving cell are served by a same base station.

41. The apparatus according to claim 34, wherein the primary serving cell and the secondary serving cell are served by different base stations.

42. A computer program product, comprising at least one non-transitory computer readable storage medium having a computer readable program code portion stored thereon, the computer readable program code portion comprising:
program code instructions for measuring a first channel quality level in a primary serving cell over a primary component carrier;
program code instructions for measuring a second channel quality level in a secondary serving cell over a secondary component carrier; and
program code instructions for performing neighbor cell measurement on a list of potential secondary component carriers if the first channel quality level is higher than a first threshold value and the second channel quality level is lower than a second threshold value.

43. The computer program product according to claim 42, wherein the first channel quality level and the second channel quality level are at least one of a reference signal received power level and a reference signal received quality level.

44. The computer program product according to claim 42, wherein the computer readable program code portion further comprising:
program code instructions for disabling neighbor cell measurement on all carriers that are configured as measurement objects if the first channel quality level is higher than the first threshold value and the second channel quality level is higher than the second threshold value.

45. The computer program product according to claim 42, wherein the computer readable program code portion further comprising:
program code instructions for enabling neighbor cell measurement on all carriers that are configured as measurement objects if the first channel quality level is lower than the first threshold value.
